(19) United States
(12) Patent Application Publication
(10) Pub. No.: US 2010/0111647 A1
(43) Pub. Date: May 6, 2010

(54) Module Handler Cylindrical Tines Equipped With Retractable Spikes, And Mounting And Drive Arrangements For The Tines

(76) Inventors: James Thomas Noonan, Bondurant, IA (US); Clarence Harold Rail, Ankeny, IA (US)

Correspondence Address: DEERE & COMPANY, ONE JOHN DEERE PLACE, MOLINE, IL, 61265, US

(21) Appl. No.: 12/264,305

(22) Filed: Nov. 4, 2008

(51) Int. Cl. A01D 90/00

(52) U.S. Cl. 414/24.5

(57) ABSTRACT

A cylindrical cotton module handling device includes an attachment having a pair of selectively spreadable, powered cylindrical tines adapted for supporting and rotating a module. Each powered tine is constructed from a cylindrical tube supported from a conventional L-shaped fork by a tubular sleeve received on, and dimensioned for fitting closely to, the horizontal leg of the conventional fork. The tubular sleeve is held in place by an L-shaped bracket forming a rearward extension of the sleeve and formed for embracing a region of the convention fork at the junction of its vertical and horizontal legs, with a retaining pin extending through vertical side plates of the bracket at a location just to the rear of the junction. An endless roller chain bearing arrangement is secured in encircling relationship to the tubular sleeve and supports the associated cylindrical tine for rotation. A hydraulic motor drive arrangement is mounted to the sleeve and has a shaft borne chain sprocket meshed with a drive chain carried by a rotating drive plates that are keyed to the cylindrical tube. A hydraulically retractable spike assembly is located inside a forward end section of the cylindrical tube and includes a plurality of spikes mounted for being selectively extended outwardly through holes in the tube for engaging a module wrapping during removal of the wrapping from the module.

### FIELD OF THE INVENTION

The present invention relates to module handling devices and more particularly relates to module handing attachments equipped with spreadable powered cylindrical tines for supporting and rotating a cylindrical module of cotton or other crop products, for example, covered in a protective covering made of plastic sheet material to a desired position for having the covering slit during removal of the covering.

### BACKGROUND OF THE INVENTION

A low cost arrangement for removing plastic wrap from cylindrical cotton or stover modules is needed, and is especially needed regarding cotton modules as part of processing the modules on a feeder floor of a cotton gin. While large cotton gins may opt for a more expensive automated arrangement for removing the plastic wrap, a lower cost arrangement is needed for the smaller gins that may require more labor, but less capital costs. The biggest problem to overcome with removing wrap from a module is getting the wrap out from under the bottom of the module during emptying the cotton contained by the wrapping onto the feeder floor. Assuming that the wrap will be cut along a line parallel to the axis of the module, a second problem arises, which is to insure that the cut does not occur at the location where the inner tail of the wrapping material is not bonded to the next adjoining wrapping layer. Ideally, the module handling device would involve an attachment for a front end loader or for a tractor three-point hitch to provide maximum versatility. Additionally, it is desirable that this module handling device be able to load modules onto flat bed trailers in the field, double-stack modules onto trailers when drop deck trailers are available or height restrictions allow, move modules in the gin yard, remove modules from a flatbed trailer and place them in the gin yard and double-stack the modules to reduce gin yard space requirements.

U.S. patent application Ser. No. 11/928,240, filed on 30 Oct. 2007, discloses such a low cost module handler, but it suffers from one or more of the disadvantages of the tine support and drive lacking durability and of manual assistance often being required for helping the driven cylindrical tines engage and wrap up the wrapping during removal of the wrapping after it has been slit.

Therefore, the problem to be solved is that of providing a module handler having spreadable, driven cylindrical tines supported and driven in a reliable manner and capable of positively engaging the plastic wrapping for effecting its removal once the wrapping has been slit lengthwise of the module.

### SUMMARY OF THE INVENTION

According to the present invention there is provided a module handler which represents an improvement over the module handler disclosed in U.S. patent application Ser. No. 11/928,240, filed on 30 Oct. 2007.

An object of the invention is to provide a module handler of the type noted above, but which has powered cylindrical tines which are supported and driven in a reliable and durable fashion, and which are equipped so as to effect a rolling up of the wrapping material during the removal of the wrapping from the module, without the need for manual assistance.

The foregoing object is accomplished by mounting cylindrical tines on each of a pair of conventional flat tines by providing a tubular sleeve dimensioned for fitting closely over a horizontal section of the flat tine, by providing a low-friction mounting arrangement defined by a length of roller chain which supports the cylindrical tine for rotation, by powering the cylindrical tine with a low speed, high torque motor arrangement and by equipping the powered, cylindrical tines with selectively retractable spikes.

### BRIEF DESCRIPTION OF THE DRAWINGS

FIG. 1 is a left front perspective view of a fork attachment for a front end loader including powered cylindrical tine assemblies constructed in accordance with the principles of the present invention.

FIG. 2 is a right side view of an adapter assembly for converting a conventional L-shaped flat tine for supporting a powered cylindrical tine.

FIG. 3 is a right side view, with parts broken away, of one of the powered cylindrical tine assemblies supported by the adapter assembly shown in FIG. 2 and installed on a conventional L-shaped tine.

FIG. 4 is a front view of one of the cylindrical tines, with a front cap removed, showing the bearing supporting the roller tine at a forward end of the adapter assembly and showing the retractable spike arrangement.

FIG. 5 is a longitudinal sectional view, taken along line 5-5 of FIG. 4, but showing only one of the sets of retractable spikes.

FIG. 6 is a side view of the cylindrical tine drive and bearing support assembly, with the drive roller chain and support bearing roller chain being omitted for clarity.

FIG. 7 is a view like that of FIG. 4, but showing the drive roller chain and support bearing roller chain.

FIG. 8 is a view showing the motor mounting plate of the drive assembly shown in FIG. 6.

FIG. 9 is a view showing one of the UHMW plastic rings of the drive assembly shown in FIG. 6.

FIG. 10 is a view showing one of the chain-driven plates of the drive assembly shown in FIG. 6.

FIG. 11 is a view showing one of the guide plates of the endless roller chain bearing support shown in FIG. 6.

FIG. 12 is a view showing one of the plates defining the support race for the endless roller chain bearing shown in FIG. 6

FIG. 13 is a perspective view showing a drive key in place for coupling the chain driven plates of FIG. 10 for driving the cylindrical tine.

FIG. 14 is a vertical sectional view taken through the powered roller assembly at a location passing between the chain-driven plates and the middle of the drive key shown in FIG. 12, and further showing an access hole provided in the cylindrical tine for permitting the installation of the drive key.

FIG. 15 is a perspective view of a portion of the cylindrical tine showing a cover installed over the access opening shown in FIG. 14.

### DESCRIPTION OF THE PREFERRED EMBODIMENT

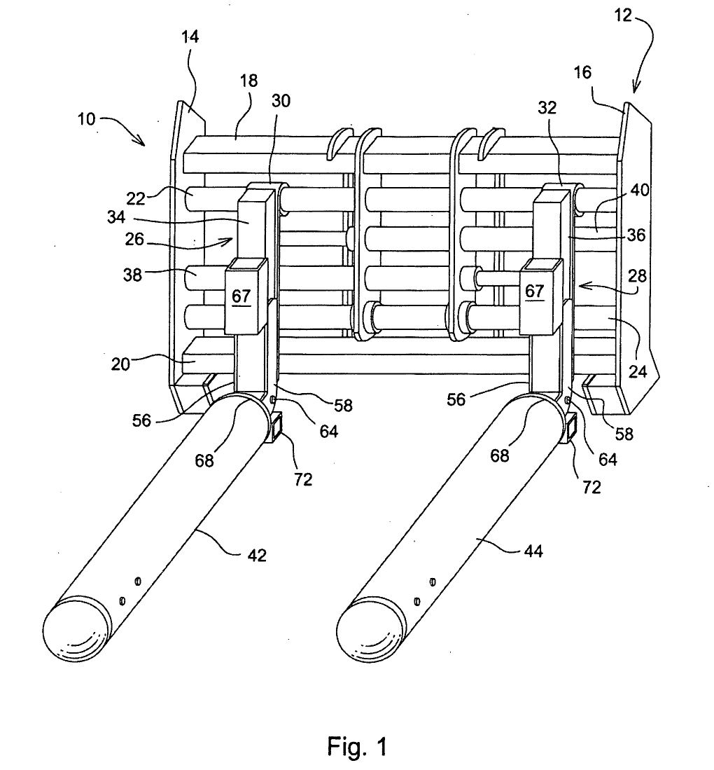

Referring now to FIG. 1, there is shown a fork implement 10 for being attached to the loader arms of a front end loader, for example. The fork implement 10 includes a support frame 12, including right- and left-hand, upright end members 14 and 16, respectively, joined together by top and bottom cross members 18 and 20, respectively. Also extending between the end members 14 and 16 are upper and lower cylindrical guide members 22 and 24, respectively. Identical, right- and left-hand, conventional L-shaped tines 26 and 28 have respective eyes 30 and 32 formed at upper ends of vertical legs 34 and 36 thereof, the eyes being mounted for sliding along the upper guide member 22. Similar eyes, not shown, are provided below the eyes 30 and 32 and mounted for sliding along the lower guide member 24. Thus, the tines 26 and 28 are mounted for movement towards and away from each other for engaging and releasing cylindrical modules of baled material, such as cotton, for example. Provided for selectively effecting such sideways movement of the right- and left-hand fork tines are horizontally disposed, extensible and retractable, right- and left-hand hydraulic actuators 38 and 40, with the actuator 38 including a cylinder having a right end anchored to the right-hand end member 14 and a rod coupled to a bracket (not shown) fixed to a rear location of the vertical leg 36 of the tine 28, and with the actuator 40 including a cylinder having a left end anchored to the left-hand end member 16 and a rod coupled to a bracket (not shown) fixed to a rear location of the vertical leg 34 of the tine 26.

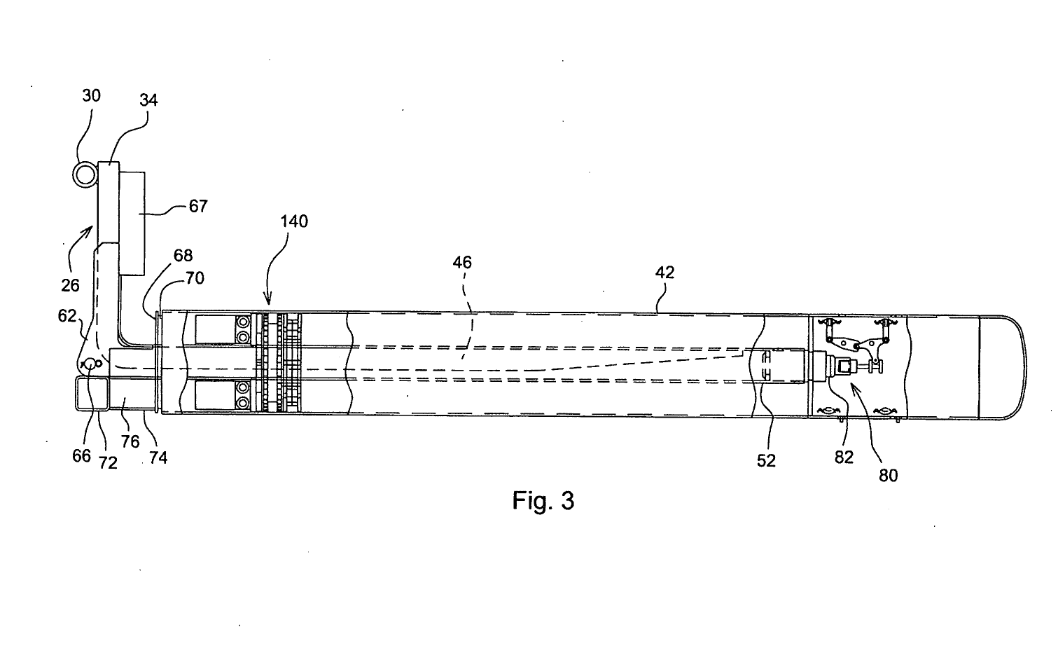

Using each of the conventional fork tines 26 and 28 as a mounting base, the tines are converted into right- and left hand, driven cylindrical tines 42 and 44, respectively, which are mounted to the horizontal legs of the conventional fork tines, in a manner described below, for rotating about respective longitudinal axes of the tines 42 and 44. It is to be understood that the structure for mounting each of the rotary tines 42 and 44 to the fork tines 26 and 28 is identical to the other and that, for the sake of simplicity, only the structure mounting the rotary tine 42 to a horizontal leg 46 of the L-shaped tine 26 is illustrated (see FIG. 3), but with structure rigidly fixed to the two tines being given the same reference numerals.

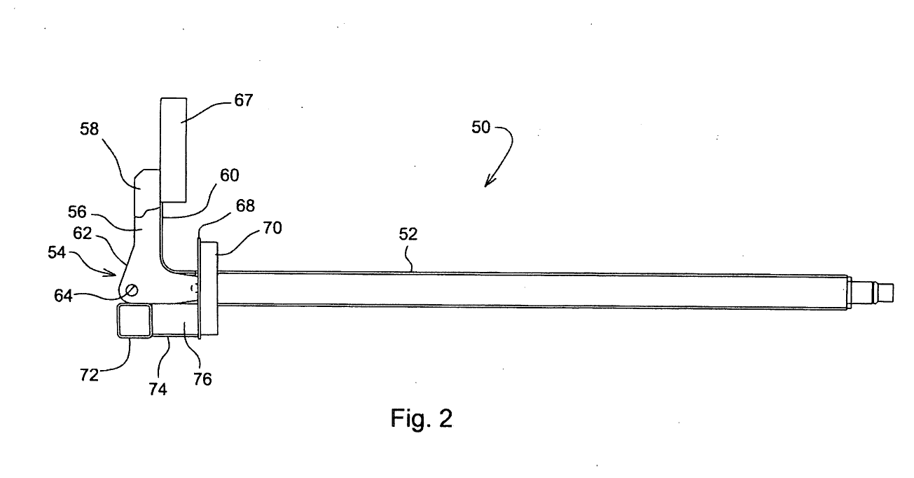

Referring now also to FIG. 2, there is shown and adapter assembly 50 for converting each tine of a fork implement having conventional L-shaped fork tines into a mounting base for the driven cylindrical tines 42 and 44. Specifically, the adapter assembly 50 includes an elongate, tubular sleeve 52 having a rectangular cross-section dimensioned for fitting closely to the horizontal leg 46 of the tine 26. Joined to a rear end of the sleeve 52 is an attachment bracket 54 including a pair of transversely spaced, parallel, generally L-shaped side plates 56 and 58 having forward regions of horizontal legs fixed to opposite sides of the sleeve 52 and having forward edges joined together by an L-shaped front plate 60 having a forward edge welded to a rear edge of a top wall of the sleeve 52 and having a top edge terminating at a location spaced below a top edge of the side plates 56 and 58. A lower rear corner region of each of the side plates 56 and 58 forms an ear 62 that projects to the rear, with aligned holes 64 being provided in the ears for receiving a locking pin 66 that engages a lower rear location of the conventional tine 26 (FIG. 3) so as to hold the sleeve 52 in place once positioned on the horizontal leg 46 of the tine 26 with the bracket 54 engaged with a front surface of the vertical leg 34. A tubular hydraulic hose guide 67 having a rectangular cross section has a bottom edge of a rear wall thereof welded to a top edge of the L-shaped front plate 60 and to upper end regions of forward edges of the L-shaped side plates 56 and 58, with it being noted that an assembled height of the side plates 56 and 58 and the hose guide 67 is approximately equal to a height dimension of the vertical leg 34 of the conventional flat tine 26. Fixed at a rear end of the sleeve 50 is a circular rear plate 68 having a cylindrical support ring 70 welded to its forward face, the ring 70 having a diameter sized for supporting a rear end region of the cylindrical tine 42 for rotation thereabout, with the plate 68 acting for reducing the amount of contaminants that might otherwise pass into the back of the driven cylindrical tine 42. The plate 68 contains appropriate openings for permitting the passage of hydraulic lines (not shown). For reducing the chances of the plate 68 from catching on an obstacle such as the back side of a feeder floor of a cotton gin or for debris to be drug into the backside of the driven cylindrical tine 42 if an operator inadvertently backs up while the cylindrical tine is on the ground surface, a support tube 72 of square cross section and having a width greater than the distance between the side plates 56 and 58 is centered beneath, and welded to lower rear edges of the side plates, with an upper front corner of the tube 72 engaging a bottom rear edge of the sleeve 52. A horizontal deflector plate 74 is welded between a lower front region of the support tube 72 and a rear surface of the rear plate 68. A transverse passage 76 is thus defined by a rear region of a bottom surface of the sleeve 52, a lower rear surface region of the plate 68, a central front region of the front side of the support tube 72 and a top surface of the plate 74; with the passage 76 serving for holding lower end regions of flexible fluid hoses (not shown) that pass downwardly through the hose guide 67.

Referring now to also to FIGS. 3-5, it can be seen that a single acting, extensible and retractable actuator 80 includes a cylinder 82 defined by a cylindrical rod located along a longitudinal axis of the sleeve 52 and having a rear end fixed to an interior of the sleeve by a rear rectangular plate 84, and having a middle location fixed to a front end of the sleeve by a front rectangular plate 86. The cylinder 82 is provided with a blind bore that extends axially from a forward end of the cylinder and receives a piston rod 88 for extension and retraction therein, the rod having appropriately sealed rear end section defining a piston (not shown) and having a forward end joined to a shift collar 90, having a purpose explained below, comprising axially spaced cylindrical sections 92 defining an annular groove 94. An inverted L-shaped fluid fitting 96 includes a vertical leg projecting through a hole provided in a top wall of the sleeve 52 and threaded into a radial work port leading to a rear end of the blind bore in the cylinder 82. A cylindrical bearing surface 98 is formed on the cylinder 82 at a region immediately forward of the front plate 86, and a circular plate 100 is welded to the interior of the cylindrical tine 42 and includes a bearing hub 102 received for rotation about the bearing surface 98.

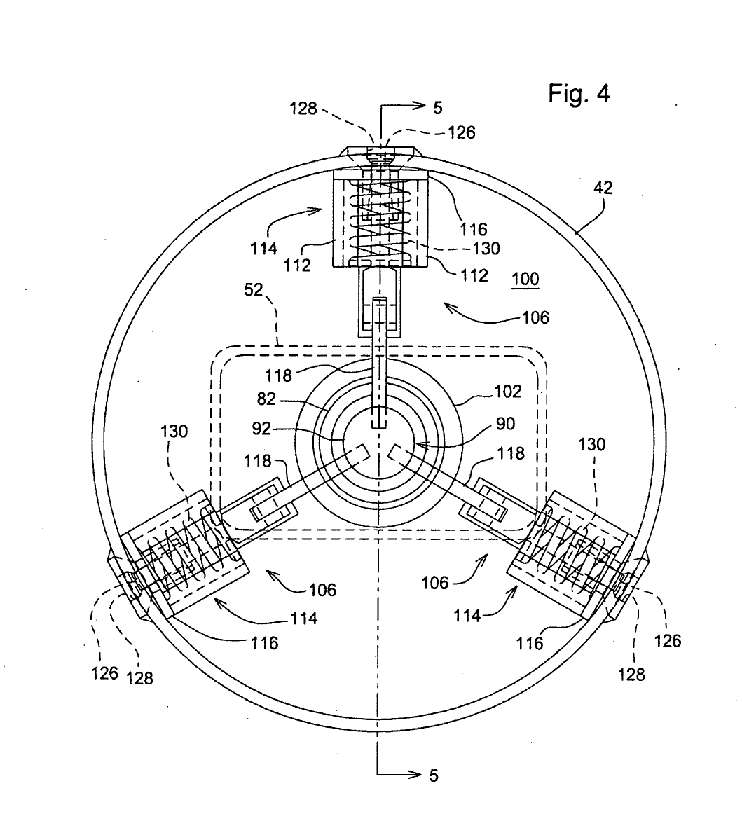

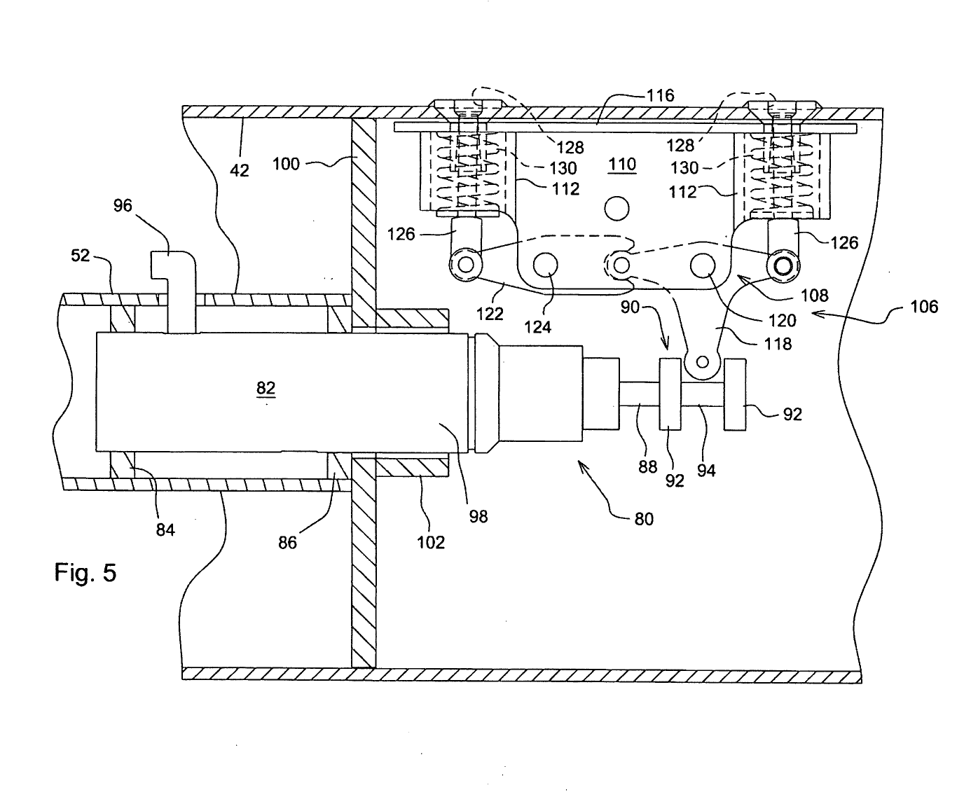

A retractable spike assembly is provided within the driven cylindrical tine 42 forwardly of the circular plate 100 and includes three identical, double-spike mechanisms 106, with only the details of one of the spike mechanisms appearing in FIG. 5. The spike mechanisms 106 are spaced equi-angularly about the rotation axis of the cylindrical tine 42. Each spike mechanism 106 includes a support including a pair of plates 108 having parallel central sections 110 having opposite ends joined to generally semi-circular sections 112, with the semi-circular sections of one plate 108 cooperating with those of the other plate to define spring housings 114, as shown in FIG. 4. Radially outer edges of the plates 108 are fixed to an axially extending rectangular base 116, which is held in place by appropriate fasteners (not shown). Located between radially inner end regions of the central sections 110 of the plates 108 is a generally triangular shaped crank arm 118 mounted for pivoting about a pin 120 inserted in a first set of aligned holes provided in the plate central sections 110, and a motion transfer link 122 mounted for pivoting about a pin 124 inserted in a second set of aligned holes provided in the plate central sections 110. The pin 120 is located about equidistant from first and second corners of the crank arm 118, with a third corner of the crank arm 118 being rounded and located within the groove 94 of the shift collar 90 at the end of the piston rod 88. A front first corner of the crank arm 118 is pinned to an inner end of a radially extending first spike 126 located axially within the adjacent spring housing 114 and having an outer end disposed within a hole 128 provided in the wall of the cylindrical tine 42. A rear second corner of the crank arm 118 is rounded and is received in a complementary shaped socket provided in a forward end of the motion transfer link 122, the link 122 having a rear end pinned to an inner end of a radially extending second spike 126 located axially within the adjacent spring housing 114 and having an outer end disposed within a second hole 128 provided in the wall of the cylindrical tine 42.

Thus, it will be appreciated that, as viewed in FIG. 5, extension of the piston rod 88 will result in the crank arm 118 pivoting counterclockwise, and in the link 122 pivoting clockwise, resulting in the spikes 126 being shifted outwardly through the holes 128. Since the actuator 80 is single-acting, there needs to be a way to retract the spikes 126 once extended. This function is accomplished by providing a coil compression spring 130 about each spike 126 in each spring housing 114, each spring acting between the adjacent base plate 116 and a washer carried on the associated spike 126 above its pinned connection with either the crank arm 108 or the link 122.

It is to be noted that each spike mechanism 106 could be replaced with a similar mechanism having a support including another spring housing and having another bell crank coupled to it and to the bottom of the third spike, and with a rounded end of the bell crank being received within a collar groove of a second collar mounted for being shifted by the piston rod 88.

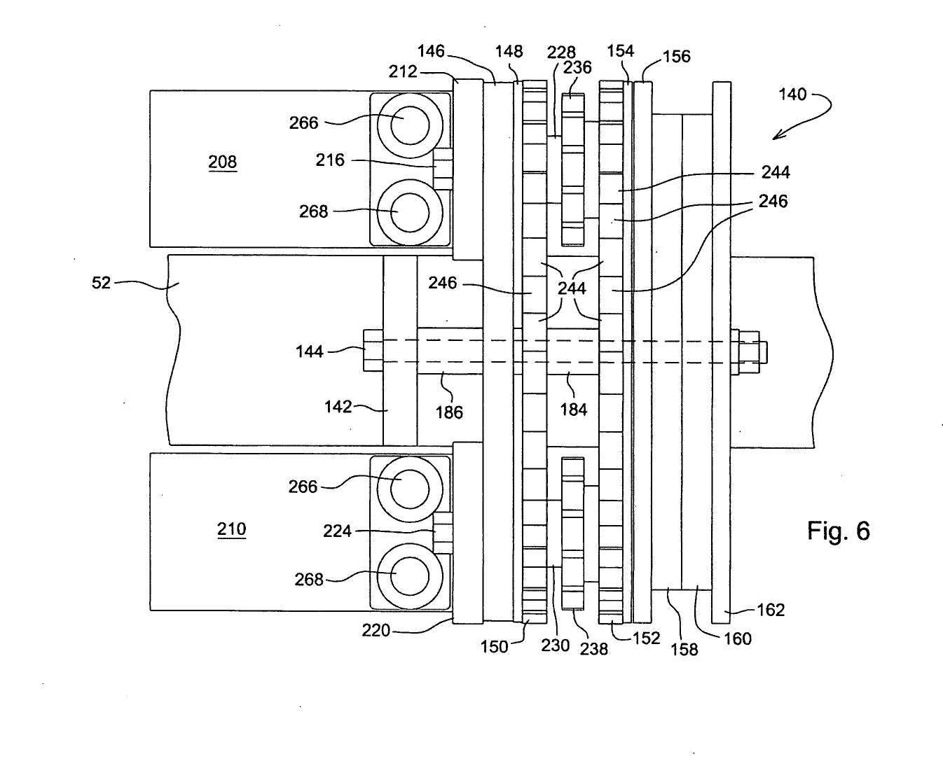

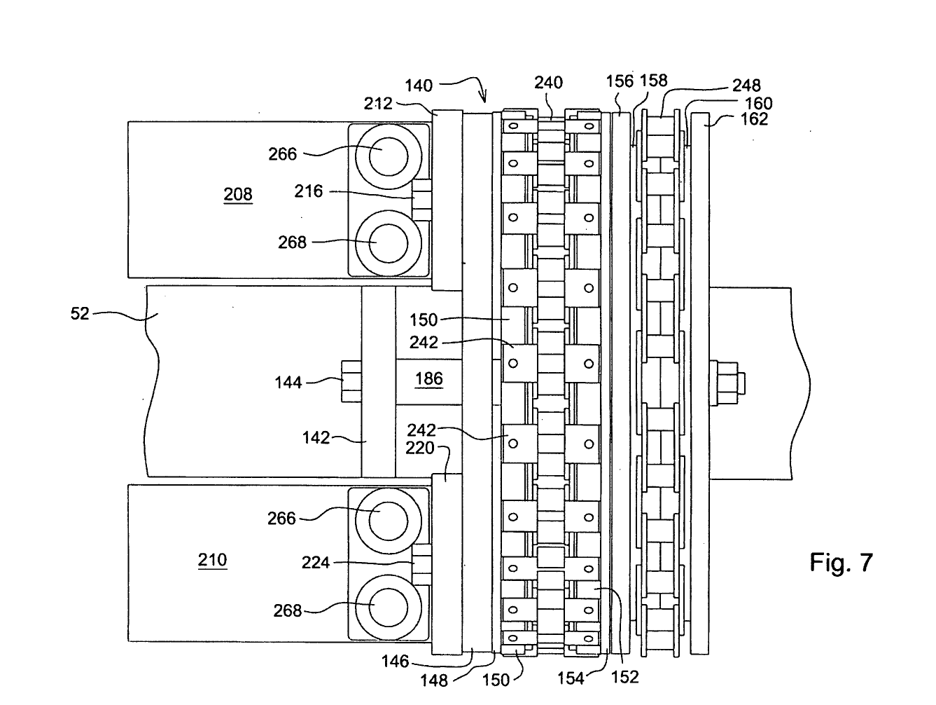

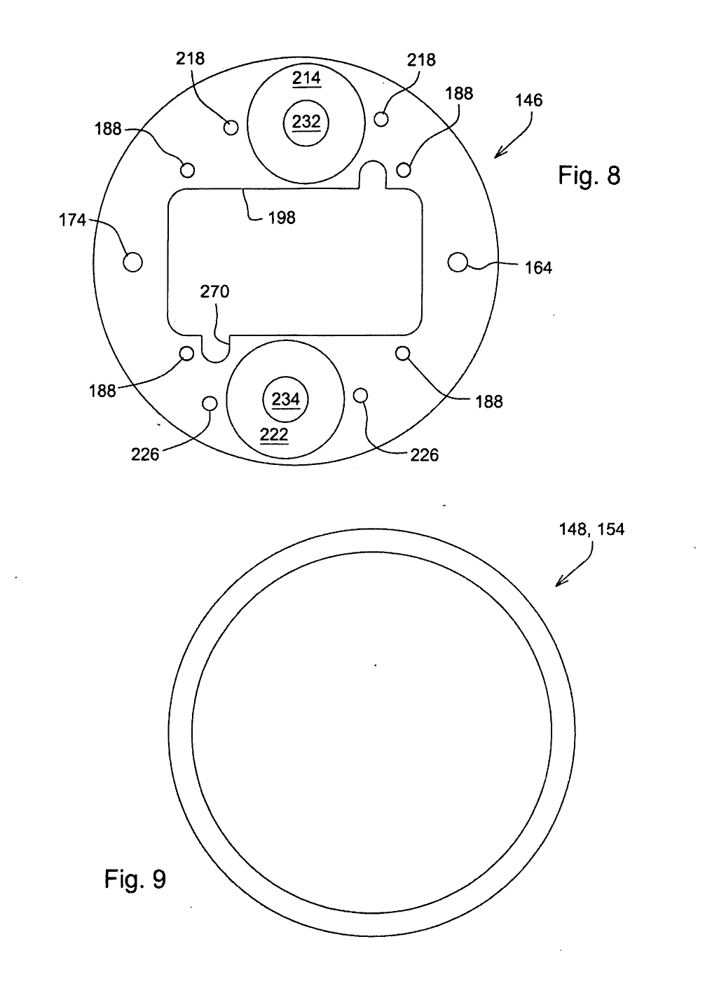

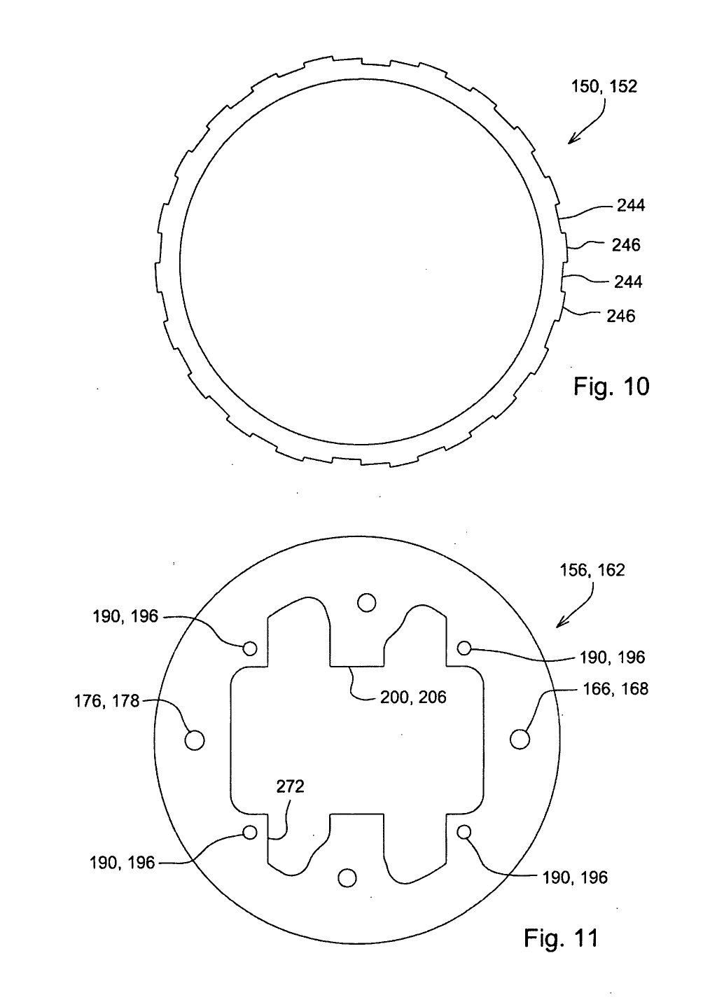

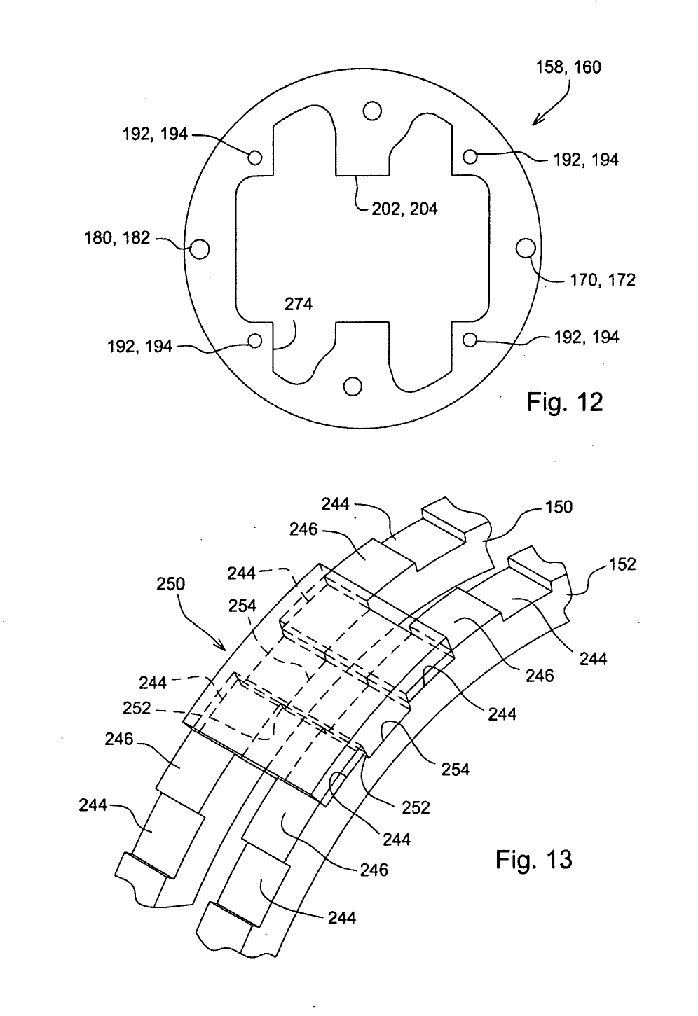

Referring now to FIG. 3, together with FIGS. 6 and 7, there is shown a cylindrical tine drive and bearing support assembly 140 comprising a mounting ear 142 fixed on each side of the support sleeve 52 at a location spaced forward from the cylindrical support ring 70, with only the ear 142 at the right side of the support sleeve 52, being shown. An assemblage of plates is mounted to the ears 142 by respective mounting bolts 144, which project forwardly through holes provided in the ears 142. Starting from the rear, the assemblage of plates comprises a motor support plate 146 (FIG. 8), a first low friction plate 148 (FIG. 9), first and second, identical toothed drive plates 150 and 152 (FIG. 10), a second low friction plate 154 identical to the first low friction plate 148, an inner bearing chain guide plate 156 (FIG. 11), first and second, identical bearing race plates 158 and 160 (FIG. 12) and an outer bearing chain guide plate 162, similar to the inner guide plate 156. It is to be noted that from a functional standpoint the bearing race plates 158 and 160 could be replaced by a single plate, from a manufacturing standpoint two plates are desired since their thickness permits them to be laser-cut, while a single plate would be outside the thickness desired for laser-cutting.

In FIGS. 8, 11, and 12, it can be seen that the plates 146, 156, 158, 160 and 162 respectively include axially aligned right-hand holes 164, 166, 168, 170 and 172 that receive one of the bolts 144, and axially aligned left-hand holes 174, 176, 178, 180 and 182, that receive the other one of the bolts 144. Since it is desired that the motor mount plate 146 and the bearing guide plates 156 and 162 be tightly clamped against the bearing race plates 158 and 160, and that the toothed drive plates 150 and 152 rotate freely, a cylindrical spacer 184 (FIG. 6) having a length sufficient for preventing the plates 150, 152 from being tightly clamped together is placed on each of the mounting bolts 144 between the motor support plate 146 and the inner bearing guide plate 156. A second cylindrical spacer 186 (FIGS. 6 and 7) is mounted on each bolt 144 between the motor support plate 146 and the mounting ear 142. Thus, it will be appreciated that when the nuts received on the bolts 144 are tightened, the ears 142, spacer 186, motor support plate 146, spacer 184 and plates 156-162 will be tightly clamped together, while the UHMW plastic plates 148, 154 and the toothed drive plates 150 and 152 will be permitted to rotate freely, with it being respectively evident in FIGS. 9 and 10 that the plastic plates and the toothed drive plates are each formed as rings having inner diameters large enough so as to avoid any interference with mounting bolts associated with the remaining plates, and outer diameters which are substantially equal to the inside diameter of the driven cylindrical tine 42.

The plates 146 and 156-162 are further held together by four bolts (not shown) respectively inserted through aligned bolt holes provided in a rectangular pattern in each of the plates, with such a pattern of four bolt holes being shown at 188 in plate 146, at 190 in plate 156, at 192 in plate 158, at 194 in plate 160 and at 196 in plate 162. It is noted that the rectangular pattern of bolt holes in each of these plates is adjacent a large rectangular opening which permits the plates to be slid over the sleeve 52 during assembly, with the rectangular opening being shown at 198 in plate 146, at 200 in plate 156, at 202 in plate 158, at 204 in plate 160, and at 206 in plate 162.

As can best be seen in FIGS. 6-8, identical, upper and lower, high torque, low speed, reversible hydraulic motors 208 and 210, respectively, are mounted to a rear face of the motor support plate 146. Specifically, the upper and lower hydraulic motors 208 and 210 are respectively located above and below the mounting sleeve 52, with a mounting structure 212 of the upper motor 208 having a planar face clamped against a circular recess 214 in the plate 146 by a pair of mounting bolts 216 inserted through respective holes provided in opposite sides of the mounting structure 212 in axial alignment with a first set of holes 218 provided in the plate 146, and with a mounting structure 220 of the lower motor 210 having a planar face clamped against a circular recess 222 in the plate 146 by a pair of mounting bolts 224 inserted through respective holes provided in opposite sides of the mounting structure in axial alignment with a second set of holes 226 provided in the support plate 146. Respective drive shafts 228 and 230 of the upper and lower motors 208 and 210 project through respective circular openings 232 and 234 located centrally in the recesses 214 and 222 of the plate 146, with each shaft 228 and 230 projecting to an axial location between the toothed drive plates 150 and 152, and respectively receiving chain drive sprockets 236 and 238. The sprockets 236 and 238 are each meshed with a drive roller chain 240 having opposite side links provided with drive tabs 242 located in recesses 244 provided between adjacent teeth 246 of each of the toothed plates 150 and 152, as shown in FIG. 7.

Also shown in FIG. 7 is a support bearing for the cylindrical fork driven cylindrical tine 42 comprising a roller chain bearing 248 wrapped tightly around the bearing race formed by the plates 158 and 160, the diameter of the rollers of the chain 248 being such as to dispose an outer surface of the rollers on a circle having a diameter substantially equal to the inside diameter of the cylindrical tine 42. Thus, the roller chain bearing 248 forms a support bearing for a rear region of the cylindrical tine 42, while the bearing surface 98 of the hydraulic actuator cylinder 82 forms a bearing support for a front region of the driven cylindrical tine 42.

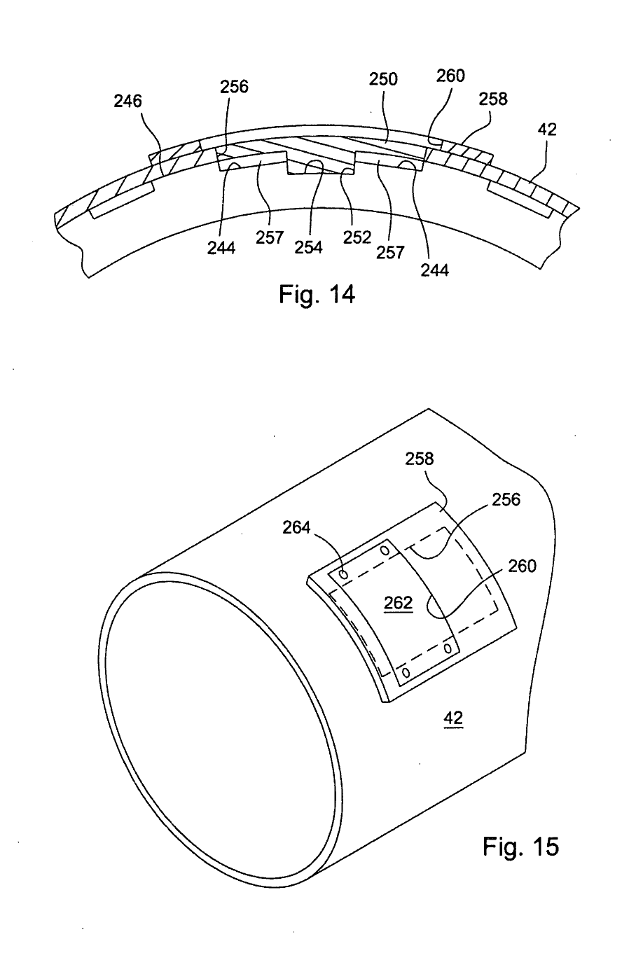

Referring now to FIGS. 7, 10 and 13-15, it can be seen that rotation of the toothed drive plates 150 and 152 caused by operation of the hydraulic motors 208 and 210 will be transferred to the cylindrical tine 42 by a drive key 250, which is in the form of a cylindrically curved rectangular plate, which bridges the toothed drive plates 150 and 152 and rests on the drive tabs 242 of the drive roller chain 240. The drive key 250 is provided with drive lugs 252 formed at its opposite sides and received within respective pockets 254 formed in the toothed drive plates 150 and 152, in lieu of one of the teeth 246 of each drive plate. As shown in FIG. 10, a second pocket 254 is provided in each drive plate at a diametrically opposite location. The provision of two, diametrically opposite pockets 254 in each of the toothed drive plates aids in the assembly of the drive key 250, as is described below. As shown in FIG. 14, an upper part of the drive key 250 is located within a keyway 256 provided in the cylindrical tine 42 so that rotation of the drive rings 150 and 152 is transferred to the cylindrical tine 42 at the keyway 256, with spaces 257 being defined between the bottom of the drive key 250 and the bottoms of the adjacent recesses 244 for receiving the drive tabs 242 of the roller chain 240. The keyway 256 is covered by a cover plate 258 welded onto the cylindrical tine 42 and provided with an access opening 260 in which is located a removable cover 262 that is secured to the driven cylindrical tine 42 by screws 264. During installation of the cylindrical tine 42 on the support sleeve 52, the cylindrical tine 42 is positioned with its keyway 256 in substantial alignment with one of the diametrical opposite pockets 254 of the drive plates 150 and 152. The driven cylindrical tine 42 is then moved axially to the rear along the support sleeve 52 until the rear end of the driven cylindrical tine 42 passes first over the roller chain bearing 248, and then the drive roller chain 240. Still further rearward movement of the cylindrical tine will bring the access opening 260, from which the cover 262 has been removed, over the drive pockets 254 of the drive plates 150 and 152. If necessary, the driven cylindrical tine 42 will be rotated a small amount to center the access opening 260 over the pockets 254. The key 250 is then placed with its pair of drive lugs 252 respectively in the pockets 254 of the toothed drive plates 150 and 152. The cylindrical tine 42 is moved to the rear so as to capture the drive key 250 and to place its rear end over the cylindrical ring 70 and closely adjacent the plate 68 at the rear of the sleeve 52. The cylindrical tine 42 is then ready for operation.

An onboard motor control valve (not shown) is provided on a motor vehicle carrying the implement 10 and selectively controls the flow of pressure fluid to, and exhaust fluid from, work/exhaust ports 266 and 268 of each of the hydraulic motors 208 and 210, by way of pressure/exhaust conduits, including sections of flexible hoses (not shown) which are routed down through the hose guides 67 and then sideways through the transverse passage 76 from its inside end, with ends of the flexible hoses being connected to L-fittings joined to L-shaped pipes that lead through respective holes provided in the vertical plate 68. Similarly, an onboard spike actuator control valve (not shown) selectively controls the flow of pressure fluid to, and exhaust fluid from the fitting 96 of the spike-engagement cylinder 80 by way of a pressure/exhaust conduit, including a flexible hose section which is routed down through the hose guides 67 similar to the hoses that supply and return fluid to the motors. A fitting couples the flexible hose section to a solid conduit (not shown) that goes through a hole provided in the plate 68 and routes along a left region of the support sleeve 52 through a notch 270 provided in the motor mounting plate 146, through a notch 272 provided in each of the support bearing guide plates 156 and 162, and through a notch 274 provided in each of the bearing race plates 158 and 160. The flexible hose sections of the various fluid supply and return conduits for the motors 208 and 210 and the spike actuator 80 are of respective lengths chosen to accommodate sideways shifting movement of the conventional L-shaped fork tines 26 and 28 effected by the selective operation of the extensible and retractable hydraulic actuators 38 and 40.

In operation, assuming a starting condition wherein the vehicle carrying the implement 10 is positioned adjacent a powered wrapper slitting device located at an end of a cotton gin feeder floor and that a cylindrical bale of plastic wrapped cotton is supported on the powered cylindrical tines 42 and 44. At this point, the spike actuator 80 will be in a non-pressurized condition wherein it and the spikes 126 are held in retracted conditions by the springs 130, as show in FIGS. 4 and 5. If it is then desired to remove the plastic wrapping from the bale so as to empty the cotton onto the gin feeder floor, the vehicle supporting the implement 10 would be driven forward so that the slitting device slits the wrapper lengthwise of the bale. The operator would then actuate to spike control actuator 80 to cause the piston rod 88 to extend, thereby causing the spikes 126 to move radially outward through the holes 128 in the roller surface and to engage the plastic wrapping on the bale with enough aggressiveness to cause the wrapper to become wrapped about the cylindrical tines 42 and 44 when they are rotated, with it to be noted that outer ends of the spike are blunt and the amount of projection of the spikes outwardly of the cylindrical tine surfaces is sufficiently small so as not to cause the plastic wrap to be punctured (alternatively, the spikes could be sufficiently sharp so as to cleanly puncture through the plastic wrap without tearing off bits of plastic which may contaminate the cotton). Rotation of the cylindrical tines 42 and 44 is next initiated by selectively operating the motors 208 and 210, associated with each of the powered rollers 42 and 44, to cause the drive plates 150 and 152 to be driven to cause the associated cylindrical tines 42 and 44 to be respectively rotated counterclockwise and clockwise, as viewed from the front, by the action of the roller drive chain 240 and associated drive key 250, with the fork actuators 38 and 40 then being actuated to cause the forks 26 and 28, and hence, the cylindrical tines 42 and 44 to be separated for allowing the cotton to be expelled onto the floor by action of the plastic cover as its opposite ends become wrapped about the cylindrical tines, noting that, once wrapping of the wrapper about the cylindrical tines 42 and 44 commences, the spikes 126 will be retracted by effecting depressurization of the spike actuator 80. After the cotton has been expelled, the vehicle is driven to a suitable wrapper collection bin and the operation of the set of motors 208 and 210 is reversed to cause the wrapping material to be unwrapped from the cylindrical tines 42 and 44 so that it drops into the collection bin. The bearing supports afforded by the bearing surface 98 of the spike actuator 80 and the rollers of the bearing roller chain 248 permit free rotation of the cylindrical rollers 42 and 44.

Thus, it will be appreciated that the adapter assembly 50 is a relatively simple structure which acts to convert the conventional, flat L-shaped tines 26 and 28 into an assembly for supporting and powering the cylindrical tines 42 and 44, and for supporting a retractable spike arrangement for the rollers.

Having described the preferred embodiment, it will become apparent that various modifications can be made without departing from the scope of the invention as defined in the accompanying claims.

1. In a cylindrical module handling device including a support frame adapted for connection to a mobile vehicle, first and second cylindrical tine support arrangements coupled to said support frame for transverse movement relative to said support frame, first and second cylindrical tines respectively being disposed in parallel relationship to each other and mounted to said first and second cylindrical tine support arrangements for rotation about respective longitudinal axes of said cylindrical tines, a reversible drive arrangement being coupled to each of said cylindrical tines for selectively effecting rotation of the tines in desired directions of rotation, and a power actuator arrangement coupled between said support frame and said first and second cylindrical tine support arrangements for selectively effecting transverse shifting of said cylindrical tines relative to said support frame, the improvement comprising: first and second spike arrangements respectively mounted to said first and second cylindrical tines and respectively including first and second sets of spike members mounted for movement between respective standby positions wherein said first and second sets of spikes are disposed close to an outer circumference of said first and second cylindrical tines, and a working position, wherein said first and second sets of spike members respectively project radially from said first and second cylindrical tines; and a second power actuator arrangement being coupled to said first and second sets of spike members and being selectively operable for effecting movement of said first and second sets of spike members between said standby and working positions.

2. The cylindrical module handling device, as set forth in claim 1, wherein said cylindrical tines are tubular and respectively include first and second sets of radially extending holes; said first and second sets of spike members being respectively aligned with said first and second sets of radially extending holes; first and second mounting arrangements respectively mounting said first and second spike members to first and second interior mounting surface locations of said first and second cylindrical tines for movement between said standby and working positions; and said second power actuator arrangement including first and second power actuators respectively coupled to said first and second sets of spike members for selectively moving said first and second sets of spike members between said standby and working positions.

3. The cylindrical module handling device, as set forth in claim 2, wherein said first and second power actuators are each a one-way extensible and retractable hydraulic actuator and are respectively located along the longitudinal axes of said first and second cylindrical tines.

4. The cylindrical module handling device, as set forth in claim 2, wherein said first and second cylindrical tines are mounted for rotating about said first and second cylindrical tine supports and have respective forward end regions extending beyond forward ends of said cylindrical tine supports; and said first and second sets of radially extending holes being respectively located in said forward end regions of said first and second cylindrical tines.

5. The cylindrical module handling device, as set forth in claim 4, wherein said first and second cylindrical tine supports respectively include first and second tubular members, each having a rectangular cross section; and said first and second power actuators being respectively mounted to forward end regions of said first and second tubular members.

6. A mounting assembly for mounting a cylindrical tine over a horizontal leg of an L-shaped flat fork tine having a rectangular cross section, comprising: an elongate tubular sleeve having a cross section closely approximating said rectangular cross section and being received on said horizontal leg; a generally L-shaped bracket joined to and forming a rearward extension of said sleeve and being disposed in confronting relationship to a region of said flat fork tine where a vertical leg of said tine joins said horizontal leg; a pin being releasably inserted through said bracket at a location closely adjacent a rear surface of said L-shaped tine, whereby said pin cooperates with said bracket for securing said sleeve in place on said tine; a cylindrical ring encircling and being fixed to a rear location of said sleeve and having an outside diameter substantially equal to an inside diameter of said cylindrical tine; a bearing assembly being fixed to said sleeve at a location spaced forwardly from said cylindrical ring, with said bearing assembly defining a support surface arrangement for engaging said inside diameter of said cylindrical tine; and said cylindrical tine being received over said tubular sleeve, with a rear end of said cylindrical tine being located about said cylindrical ring, and with a region of said cylindrical tine located between opposite ends of said cylindrical tine being supported on said bearing assembly.

7. The mounting assembly, as defined in claim 6, wherein a plate extends between said tubular sleeve and said ring so as to prevent entry of contaminant materials into a rear end of said cylindrical tine.

8. The mounting assembly, as defined in claim 6 wherein said bearing assembly includes a continuous link chain including lubricated rollers being in supporting engagement with an inner surface of said cylindrical tine.

9. In combination with a tubular cylindrical tine mounted for rotating about a longitudinal axis of said cylindrical tine, a drive assembly, comprising: a motor mounting plate located inside, and mounted in fixed relationship to, said cylindrical tine in a plane extending perpendicular to said longitudinal axis; at least one hydraulic motor being mounted to said motor mounting plate and having an output shaft disposed parallel to said longitudinal axis; a chain drive sprocket being fixed on said output shaft; a pair of toothed drive plates located in axially spaced relationship to each other at opposite sides of said pinion gear, with each drive plate having an outside diameter approximating an inside diameter of said cylindrical tine; an endless drive chain having a plurality of axially aligned, oppositely extending pairs of drive tabs being respectively engaged in recesses defined between adjacent teeth of said pair of toothed drive plates; said drive sprocket being meshed with said drive chain; a drive key defined by a cylindrically curved plate spanning said drive chain and having opposite ends respectively coupled for being driven by said pair of drive plates; and said cylindrical tine having a keyway receiving said drive key, whereby rotation of said drive plates by said at least one hydraulic motor is transferred to said cylindrical tine.

10. The combination, as defined in claim 9, wherein a second hydraulic motor is mounted to said motor mounting plate at an opposite side of said motor mounting plate from said first-mentioned motor; and said second hydraulic motor including a second output shaft carrying a second drive sprocket meshed with said drive chain.

11. In combination with a cylindrical tine mounted for rotating about a support member disposed along a longitudinal axis of said cylindrical fork, a retractable spike assembly, comprising; an extensible and retractable motor being mounted to said support member and having an output member selectively moveable along said axis; a plurality of openings being provided in a wall region of said cylindrical tine located adjacent said output member; a plurality of spikes being mounted inside said cylindrical tine for movement between a retracted position respectively within said plurality of openings and an extended position wherein the spikes extend substantially perpendicular to said axis and have ends projecting at least a short distance radially from a circumference of said cylindrical tine.

12. The combination, as defined in claim 11, wherein said plurality of openings are defined by circular holes and said spikes are respectively mounted for movement within said holes.

13. The combination, as defined in claim 12, wherein the mounting for said spikes includes a spring associated with, and biasing, each spike toward said retraced position and resiliently yielding upon actuation of said extensible and retractable motor so as to permit each spike to move to its extended position.

14. The combination, as defined in claim 11, wherein said tine assembly includes a plurality of tine mounting brackets fixed to an inner surface of said wall region of said cylindrical tine at locations spaced equally about a circumference of said wall region; each mounting bracket including a pair of parallel, substantially radially extending plates defining a pair of axially spaced spring housings respectively containing a pair of coil springs surrounding, and respectively biasing a pair of said spikes towards its retracted position; a linkage assembly being mounted to each of said mounting brackets and being coupled between said output member and said pair of said spikes so as to transfer linear axial motion of said output member to effect linear radial motion of said pair of said spikes.

15. The combination, as defined in claim 14, wherein said output member includes an annular collar; and said linkage assembly including a bell crank having one leg engaged with said collar, a second leg engaged with a further link and a third leg coupled with a first of said pair of said spikes; and said further link having an end coupled with a second of said pair of said spikes.

16. A drive and bearing support arrangement for supporting a tubular cylindrical tine of a module handling implement for rotation about a horizontal leg of a conventional L-shaped fork tine, comprising: a tubular sleeve having a rectangular cross section dimensioned for fitting closely to said horizontal leg of said fork; an assembly of circular plates encircling, and being concentric to a longitudinal axis of, said sleeve; said circular plates including, as considered proceeding from rear to front, a motor mounting plate, first and second identical toothed drive plates, a first bearing chain guide plate, at least one bearing race plate and a second bearing chain guide plate; a fastening assembly securing said motor mounting plate, first bearing guide plate, at least one bearing race plate and second bearing guide plate to each other and to said tubular sleeve with said motor mounting plate being fixed in an axially spaced relationship to said first bearing guide plate and with said first bearing guide plate, at least one bearing race and said second bearing guide plate being clamped together; said motor mounting plate and first and second bearing guide plates having diameters approximately equal to an inside diameter of said cylindrical tine, and said at least one bearing race plate having a diameter smaller than that of said first and second bearing guide plates; an endless bearing chain being disposed in engagement with said at least one bearing race plate and having a periphery disposed at a diameter slightly larger than that of said bearing guide plates so that said cylindrical tine fits snugly over said bearing chain; at least one drive motor being mounted to said mounting plate and having an output shaft carrying a drive sprocket located between said first and second drive plates; and a drive chain including drive tabs engaged with recesses located between teeth of said first and second drive plates, whereby said drive plates will be rotated by operation of said at least one drive motor.

17. The drive and bearing support arrangement defined in claim 16, wherein said fastening assembly includes mounting ears secured to opposite sides of said sleeve at locations spaced a preselected amount from a rear of said sleeve, mounting bolts inserted through aligned holes in said ears, motor mounting plate, first bearing guide plate, at least one bearing race plate and second bearing guide plate.

18. The drive and bearing support arrangement defined in claim 16 and further including a second bearing race plate which is identical to, and mounted side-by-side-with, said at least one bearing race plate.

19. The drive and bearing support arrangement defined in claim 16 and further including a second drive motor mounted to said motor support plate at an opposite side of said sleeve from said at least one drive motor; and said second drive motor including a second output Shaft carrying a second drive sprocket meshed with said drive chain.
